(19) United States
(12) Patent Application Publication
(10) Pub. No.: US 2017/0052985 A1
(43) Pub. Date: Feb. 23, 2017

(54) NORMALIZING VALUES IN DATA TABLES

(71) Applicant: International Business Machines Corporation, Armonk, NY (US)

(72) Inventors: Chinnappa Guggilla, Bangalore (IN); Joy Mustafi, Kolkata (IN)

(21) Appl. No.: 15/195,233

(22) Filed: Jun. 28, 2016

Related U.S. Application Data
(63) Continuation of application No. 14/830,780, filed on Aug. 20, 2015.

(51) Int. Cl. G06F 17/30

(52) U.S. Cl. CPC G06F 17/30303; G06F 17/30327; G06F 17/30339

(57) ABSTRACT

A computer-implemented method for normalizing data tables, where a lexical values and the structure of data within a data table are identified and interpreted. The data table is transformed into a tree form, representing a hierarchical relationship among the lexical values. Information to be normalized is identified. A normalization dictionary with aggregated statistical information of lexical values and corresponding word-senses is generated. And information to be normalized is normalized based on the normalization dictionary.

### BACKGROUND

The present disclosure relates generally to the field of computer systems for normalizing ambiguous or non-homogeneous values with a data in tables.

Language processing is a field of computer science, artificial intelligence, and linguistics which is concerned with the interactions between computers and human natural languages. As such, language processing is related to the area of human computer interaction. Image processing is any form of signal processing for which the input is an image, such as a photograph or video frame. The output of image processing may be either an image or a set of characteristics or parameters related to the image. Most image processing techniques involve treating the image as a two-dimensional signal and applying standard signal-processing techniques to it. Optical character recognition (OCR) is the mechanical or electronic conversion of scanned images of hand-written, type-written or printed text into machine-encoded text. OCR is widely used as a form of data entry from some sort of original paper data source, whether documents, sales receipts, mail, or any number of printed records.

Language within tables consist of various types of data such as text, numbers, graphical symbols, binary information, emoticons, ratings, percentages, currency, etc. Sometimes tables are not presented in a structured manner and missing certain information. Non-normalized or semi-structured tables contain information which is partial and lead to misinterpretations. Normalization of ratings can include adjusting values measured on different scales to a notionally common scale, often prior to averaging.

### SUMMARY

The present disclosure implements a system, method, and computer program product which normalizes data in tables.

In an embodiment, a method for normalizing data in tables, is provided. The method includes identifying and interpreting a plurality of lexical value within a data table, identifying and interpreting a structure of the data table, transforming the data table into a tree form, where the tree form simulates a hierarchical tree structure representing a relationship among the plurality of lexical values as a set of linked nodes, identifying information to be normalized, generating a normalization dictionary comprising one or more arrays of aggregated statistical information of lexical values and corresponding word-senses, and normalizing the information to be normalized using the normalization dictionary.

In another embodiment, a computer program product for normalizing data in tables is provided. The computer program product includes a computer-readable storage medium having program code embodied therewith, the program code executable by a processor of a computer to perform a method comprising identifying and interpreting a plurality of lexical value within a data table, identifying and interpreting a structure of the data table, transforming the data table into a tree form, where the tree form simulates a hierarchical tree structure representing a relationship among the plurality of lexical values as a set of linked nodes, identifying information to be normalized, generating a normalization dictionary comprising one or more arrays of aggregated statistical information of lexical values and corresponding word-senses, and normalizing the information to be normalized using the normalization dictionary.

In an embodiment, a computer system for normalizing data in tables, is provided. The computer system includes one or more computer processors, one or more computer-readable storage media. The program instructions are stored on the computer-readable storage media for execution by at the one or more processors, the program instructions comprise instructions to identify and interpret a plurality of lexical value within a data table, instructions to identify and interpret a structure of the data table, instructions to transform the data table into a tree form, where the tree form simulates a hierarchical tree structure representing a relationship among the plurality of lexical values as a set of linked nodes, instructions to identify information to be normalized, generating a normalization dictionary comprising one or more arrays of aggregated statistical information of lexical values and corresponding word-senses, and instructions to normalize the information to be normalized using the normalization dictionary.

### BRIEF DESCRIPTION OF THE SEVERAL VIEWS OF THE DRAWINGS

FIG. 1A is schematic block diagram depicting an exemplary computing environment for a normalizing program, in accordance with an aspect of the present disclosure.

FIG. 1B is as schematic block diagram depicting components of a normalizing program, in accordance with an aspect of the present disclosure.

FIG. 2 is a flowchart depicting operational steps of a method for a normalizing program, in accordance with an embodiment of the present disclosure.

FIG. 3A is a schematic block diagram depicting a semi-structured data table, according to an embodiment of the present disclosure.

FIG. 3B is a schematic block diagram depicting a tree form, according to an embodiment of the present disclosure.

FIG. 3C is a schematic block diagram depicting a normalizing dictionary, according to an embodiment of the present disclosure.

FIG. 3D is a schematic block diagram depicting a normalized tree form, according to an embodiment of the present disclosure.

FIG. 4 is a block diagram of internal and external components of computers and servers depicted in FIG. 1, according an embodiment of the present disclosure.

### DETAILED DESCRIPTION

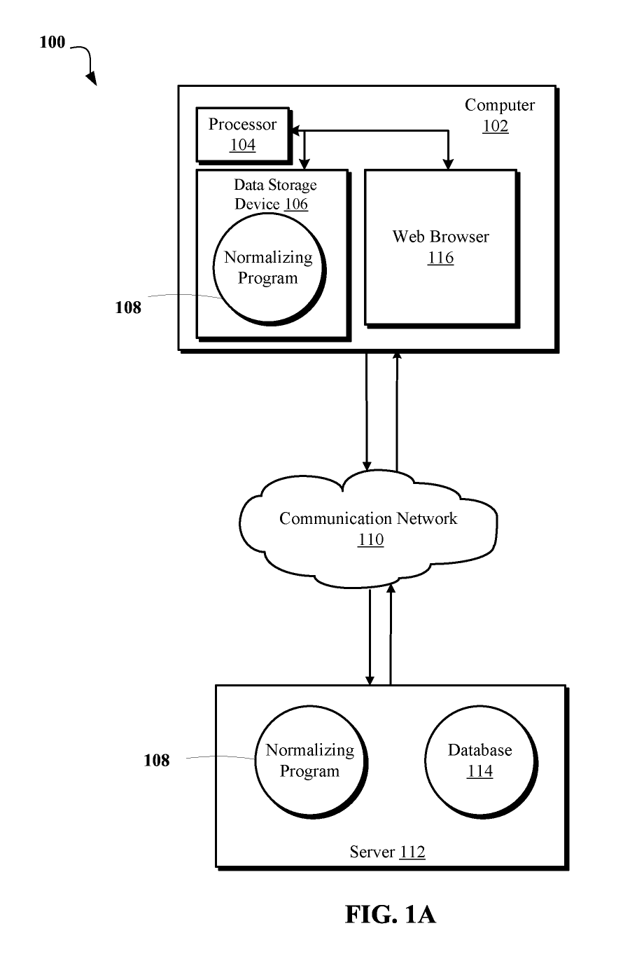

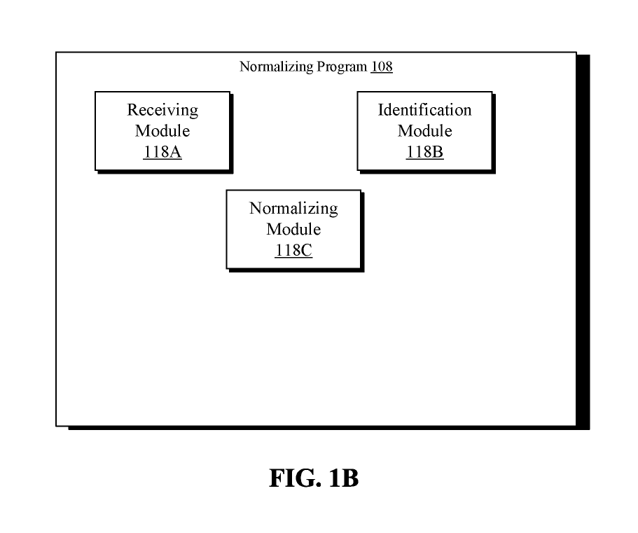

FIG. 1A depicts an exemplary computing environment 100 for managing the display of application forms within a web-based application. In various embodiments of the present disclosure, the environment 100 may include a computer 102 and server 112 connected over communication network 110.

A computer 102 may include a processor 104 and a data storage device 106 that is enabled to run a normalizing program 108 and a web browser 116 that displays an application form. Non-limiting examples of a web browser may include: Firefox®, Explorer®, or any other web browser. All brand names and/or trademarks used herein are the property of their respective owners.

The computing environment 100 may also include a server 112 with a database 114. The server 112 may be enabled to run a program such as a normalizing program 108. A communication network 110 may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. Communication network 110 may also include a number of different types of networks, such as, for example, an intranet, a local area network (LAN), or a wide area network (WAN).

It should be appreciated that FIG. 1A provides only an illustration of one implementation and does not imply any limitations with regard to the environments in which different embodiments may be implemented. Many modifications to the depicted environments may be made based on design and implementation requirements.

The computer 102 may communicate with the server 112 via the communication network 110. The communication network 110 may include connections, such as wire, wireless communication links, or fiber optic cables.

The computer 102 and the server 112 may be, for example, a mobile device, a telephone, a personal digital assistant, a netbook, a laptop computer, a tablet computer, a desktop computer, or any type of computing device capable of running a program and accessing a network. A program, such as a normalizing program 108 may run on the computer 102 or on the server 112. It should be appreciated that normalizing program 108 has the same component and operation methods regardless of whether it is run on the server 112 or computer 102. Therefore normalizing program 108 applies to both normalizing program 108 run on a computer 102 and normalizing program 108 run on the server 112 are interchangeably used throughout this disclosure.

Referring now to FIG. 1B, a normalizing program 108 may include a receiving module 118A, identification module 118B, and normalization module 118C. The receiving module 118A may receive a chart and/or supplemental or attached corpus/other documents. Identification module 118B may identify and interpret the text and other lexical values within table, and the overall structure of the table. Identification module 118B may also transform the table into a hierarchical tree format. Identification module 118B may further identify the information to be normalized within the table. Normalization module 118C may generate a normalization dictionary using both intrinsic and extrinsic sources and normalize the information to be normalized (which are identified by the identification module 118B) based on the normalization dictionary.

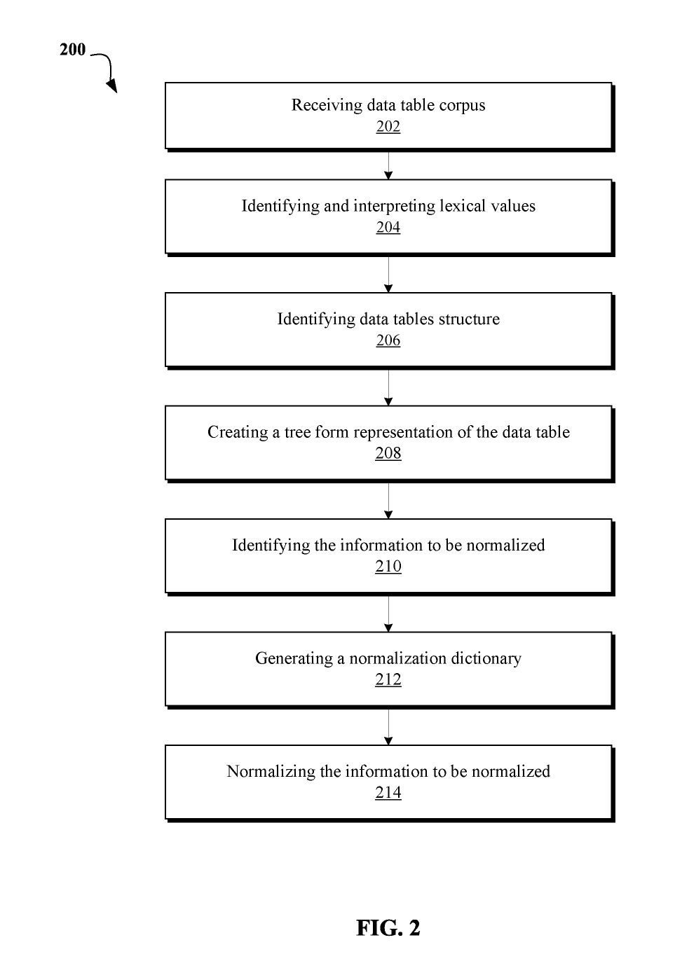

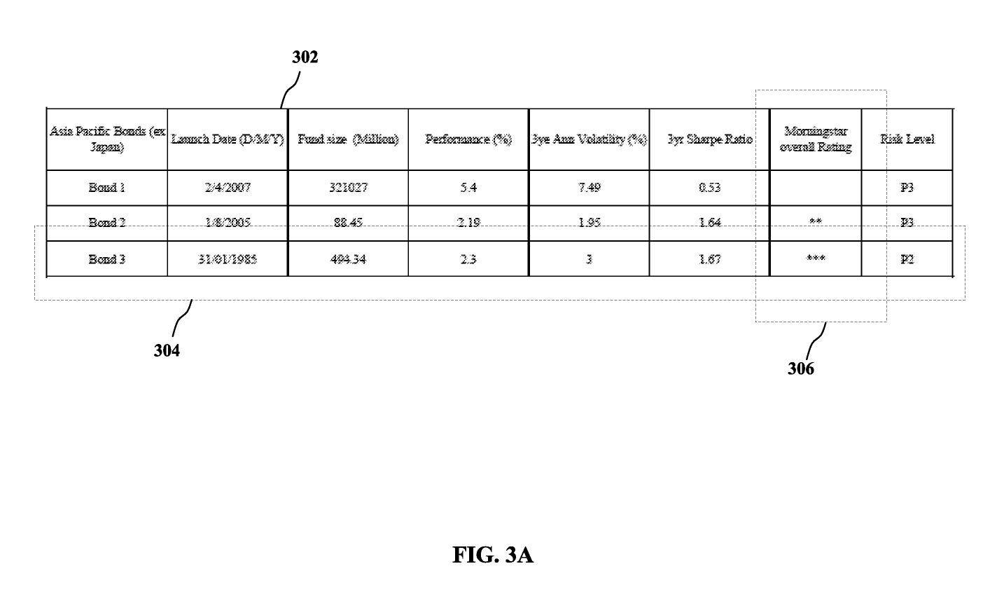

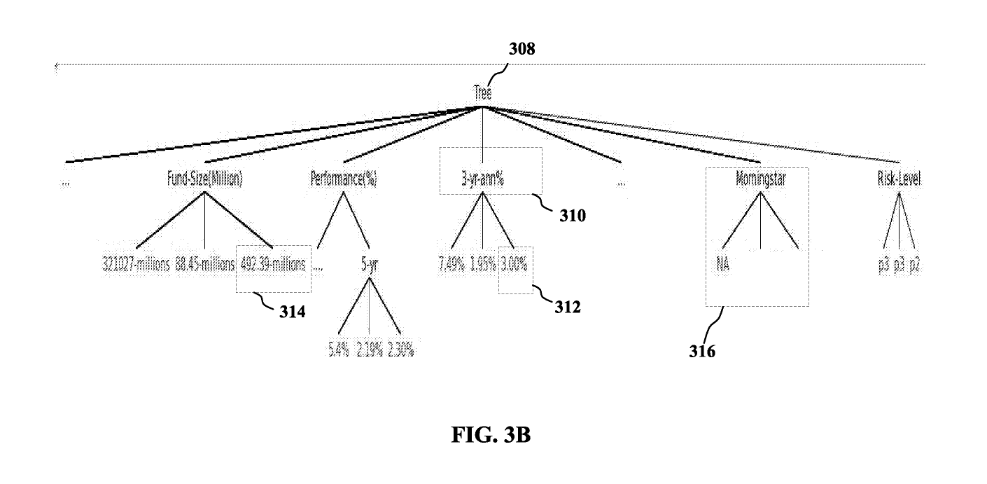

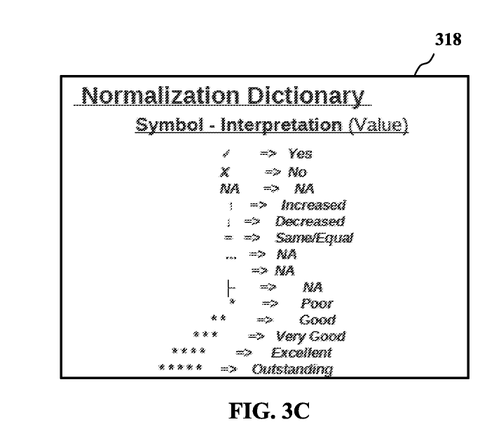

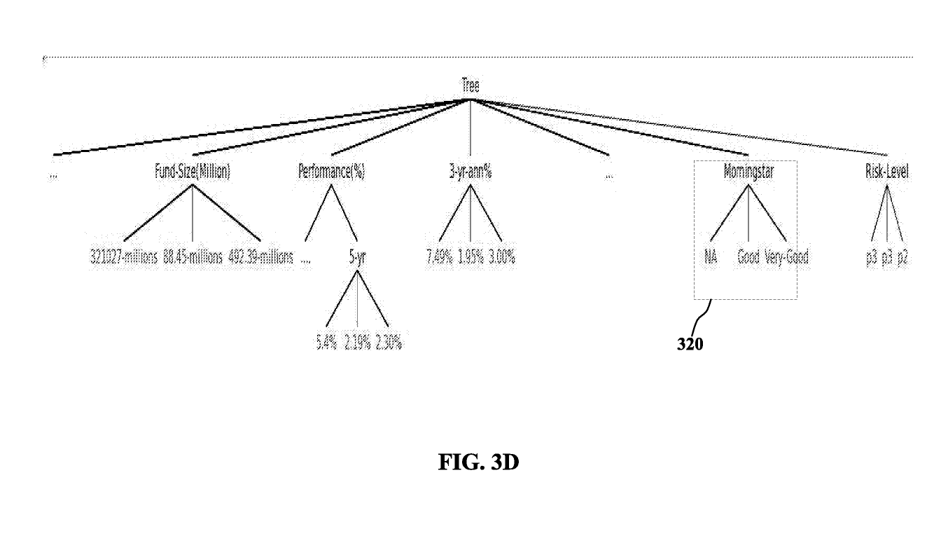

In reference to FIG. 2, steps of method 200, in conjunction with the depicted embodiment in FIG. 3, may be implemented using one or more modules of a computer program, for example, normalizing program 108, and executed by a processor of a computer, such as computer 102. It should be appreciated that FIG. 2 does not imply any limitations with regard to the environments or embodiments which may be implemented. Many modifications to the depicted environment or embodiment shown in FIG. 2 may be made.

At 202 receiving module 118A may receive a data table. A data table is an arrangement of data. A data table may appear in print media, handwritten notes, computer software, architectural ornamentation, and many other places. Data tables differ significantly in variety, structure, and flexibility. A structured data table is a data table which organizes information in form of lexical values into rows and columns. It can be used to both store and display data in a structured format. A structured data table differs from a non-structured or semi-structured data table in the fact that a in a structured data table every item of information belongs to a certain heather and is clearly marked. For example in a row and column system any particular lexical value within the table belongs to a particular row and column and the heather or other information regarding the column and rows define the type/category of information which said lexical value represents. If a data table is not structured it is a non-structured data table. However, a structured data table which I missing one or more column or row identifications may be a semi-structured data table. A lexical value simply relates to whatever characters or information which the data table contains. Lexical value may be a word, n-gram, or other mathematical, Greek numeral, or other characters which the creator of the data table has utilized to convey a message.

Receiving module 118A may receive the geometric shapes, word(s) and/or metadata associated with the words or lexical values from a user or a computer implemented system. Non-limiting examples of an input source may be pictures, scanned images, typed text, or inputting a corpus electronically from a computer implemented source such as an electronic device (e.g. cell phones, tablets, or other electronic devices with speech recognition ability). The data table may be in various formats. Non-limiting examples of a data table comprise hand-drawn, bitmap (scanned, softcopy, or other files such as files with bmp, jpg, png, or tif extensions), or vector graphics (e.g. files with ppt extension). It must be appreciated that a hand-drawn data table may be converted to a bitmap. In one embodiment, the hand-drawn data table may be scanned or photographed and converted into bitmap images. This may be referred to as digitization. Vector graphics is the use of geometrical primitives such as points, lines, curves, and shapes or polygons—all of which are based on mathematical expressions—to represent images in computer graphics. In one embodiment, user has created a data table in a software with ppt extension (i.e. Microsoft Power Point™). In that embodiment, the data table has already been reduced to shapes recognizable by a computer program. In this embodiment, receiving module 118A may receive a file which includes the data table. It must also be appreciated that in an embodiment the words and shapes of the diagram may not be received from the same source. For example, in an embodiment, a user may fill in the text in a pre-drawn data table by spoken words.

In the present embodiment, depicted in FIG. 3A-D, receiving module 118A receives data table 302 through electronic inputting the corpus. Data table 302 is a part of a word document. In the present embodiment, user inputs the word document including data table 302 electronically in the normalizing program 108. Data table 302 is a semi structured data table which includes lexical values (including words, mathematical signs, numbers, and acronyms). Data table 302 is organized in a row and column method which means the data/information contained within data table 302 belongs to rows and columns such as row 304 and column 306. Every column has a heather title. For example, column 306 has a heather title of “Morningstar Overall Rating”. Receiving module 118A, in the present embodiment, also receives the geometric shapes of the data table 302.

At blocks 204 and 206, identification module 118B may identify and interpret lexical values and the structure of the data table. Identification module 118B may identify various geometric shapes within the received data table. Identification module 118B, in one embodiment, may analyze the data table using various image processing techniques, such as: edge detection, boundary of shapes and types of shapes, connection identification, text labels extraction (using standard OCR system), continuity of diagram and jump-links retrieval, legend (color overlay) classification, or convert into vector graphics. Identification module 118B may reduce all the geometric shapes to geometric primitives. A geometric primitive is a simplest irreducible geometric element. For example, identification module 118B may reduce a triangle (which is a geometric shape) into three connecting lines (which are the simplest irreducible geometric elements). It must also be appreciated that if the received data table is in vector graphics, in that embodiment, the shapes are already in recognizable format for the identification module. Identification module 118B may also identify the text within the data table. Identification module 118B may use Natural Language Processing methods and OCR methods in order to identify the text within the data table. Identification module 118B may also combined the identified imagelets and text in order to create an identified or mapped data table.

In the present embodiment, receiving module 118A receives the geometric shapes in form of a vector gram because data table 302 has been created by a computer software and is easily recognizable. Identification module 118B, in the present embodiment, recognizes the shapes and the recognizable structure of data table 302. Identification module 118B also, using techniques such as OCR, identifies the words and lexical values of the data table 302.

At block 208, identification module 118B may create a tree form representation of the data table. Identification module 118B may identify the associations between the geometric shapes within the data table. Identification module 118B, in an embodiment, may also analyze the images for certain predefined geometric shapes. Identification module 118B may, using a predefined criteria and values, analyze, identify the connectors and place holders and determine their corresponding hierarchical relation. Place holders” are geometrical objects or shapes with texts (e.g. rectangle, square, circle, including directional arrow and line, where the texts can be inside or outside the shape. In an embodiment, identification module 118B may construct tree from the base column and remaining columns of the data table, where header becomes the root nodes, sub-headers, category-headers are denoted as intermediate nodes and all the table cell numerical values are denoted as leaf nodes in the tree. If any table cell values or headers are absent, identification module 118B may designate Null node for them. Identification module 118B may encode each header type, and cell value type information in the node, Row-level header in table contains corresponding cell values under each column-header, these values appear in left-most child of each node (column-header) in the tree. Column level-header in table may contain corresponding cell values in entire column and may be homogeneous.

A single hierarchical tree can be used to compactly represent semi-structured table in tree form which in turn helps in accessing homogeneous data across rows and columns at leaf level. This provides greater flexibility in normalizing, and handling missing row-wise and column wise data at bottom of the tree leaf level. Tree form may preserve the order and structure of the table data for maintaining semantics of the data encoded in table.

In the present embodiment, identification module 118B, uses the recognized structure of the data table 302 and generate a tree form representation of the data table. A tree form representation may represent the data table in a plurality of linked nodes. In the present embodiment, tree form 308 represents data table 302. It must be appreciated that tree form 308 is not shown in its entirety in FIG. 3B for ease of reader's ability to follow. Only the relevant portions to the normalizing program 108 is show in tree form 308. Tree form 308 has many sub-heathers such as sub-heather 310. Sub-heather 310 corresponds to “3-yr Ann. Volatility” column of data table 302. In the present embodiment, sub heathers are also divided by nodes such as node 312. Each node denotes and corresponds to the content (i.e. data/information/lexical values) within the data table. For example node 312 corresponds to 3-yr Ann. volatility of Bond 3. In the present embodiment, identification module 118B, uses consistency in location of the nodes in order to keep track of the lexical values. For example, tree form 308 has three nodes per sub-heather. The nodes correspond to the lexical values and of course the reason for having 3 nodes is that the data table 302 comprises information regarding bond 1-3. It must be mentioned that tree form 308 is generated consistently, meaning that every node on the right pertains information of the lexical values for the same category of information. In short, every right node corresponds to the same information. For example, node 312 and node 314 (which are both located as the furthest to the right under their respective sub-heathers) both correspond to bond 3.

At block 210, identification module 118B, may identify words to be normalized. Identification module 118B may use the identified meaning and interpretation of the values within the data table to identify the ambiguous, missing, or non-homogeneous lexical values. Identification module 118B, in an embodiment, may check the meaning of all the identified words/lexical values within the data table and determine which word is ambiguous. In another embodiment, identification module 118B may determine the missing lexical values within the data table.

In the present embodiment, identification module 118B, may identify sub-heather 316 and its corresponding nodes as information to be normalized. Sub-heather 316 corresponds to column 306 (i.e. morning star overall rating). Identification module 118B identifies that the first node (corresponding to Bond 1) is null because the information is missing in data table 302 and therefore is information to be normalized. Identification module further identifies the second and third node to be information to be normalized because the lexical values are * and **. Identification module 118C determines that these values are not homogeneous with the rest of the table which has words and numbers. Generally if the format of a lexical value differs with the other lexical values within the same category, the former may be deemed to be non-homogeneous. This simply means that the information is not the same type as the other information. For example, in an embodiment, if all the lexical values are two digit numbers, a lexical value which includes a word may be deemed non-homogeneous.

At block 212, normalization module 118C may generate a normalization dictionary. A normalization table is a domain table comprises one or more arrays of aggregated information regarding lexical values, and one or more of corresponding word-senses. A normalization dictionary may be augmented by both extrinsic and intrinsic sources, traditional lexical value word senses and word-senses based on the corpus of the data table or the attached documents. Normalization module 118C, in one embodiment, may use factors such as frequency of usage, frequency of occurrence, frequency of co-occurrence with other words, in order to create a context based normalization dictionary. In another embodiment, normalization table may be binary information which is encoded in various lexical and symbolic forms such as Yes/No, 0/1, Tick/Cross, ternary symbols such as −/+/=, upArrow/DownArrow/=, ratings such as *,**,***,****,*****, Humor and Emotional symbols and other color encodings such as black/white/blue, etc. Normalization dictionary, in another embodiment, may be built consisting of various cell values such as graphical symbols, lexical values and conditional marks from set of identified tables containing non-uniform data. Interpretation of these symbols and values may be manually configured or determined based on different parts of the corpus such as table context or document context. Different set of symbols or lexical values may be grouped and interpreted based on their intended meaning in each potential table to be normalized. For certain conditional data values in the table, corresponding interpretations may be obtained from patterns which are compiled from table and document text. Normalization dictionary may be limited in size initially, and it may be be expanded to accommodate newer patterns based on the type of the corpus it is based on. Furthermore, when a normalization dictionary cannot accommodate a word-sense, the word senses may be supplied or configured externally from an outside source such as a dictionary or a context based dictionary or encyclopedia.

In the present embodiment, normalization module 118C generates dictionary 318 based on pre-determined word senses. The dictionary 318 of the present embodiment, includes a symbol interpretation value titles and listed symbols commonly used and their corresponding word senses; for example . . . has a corresponding word sense of not applicable. Normalization module 118C dictionary 318 based on traditional values of certain symbols within data tables.

At 214, normalization module 118C may normalize the information to be normalized. Normalization, within the context of present disclosure, is determining a word sense for information to be normalized using a normalization dictionary. Normalization module 118C, in one embodiment, may utilize row-level header and corresponding column header values and normalize them by matching in ‘Normalization’ dictionary word senses. All leaf node values under each column header may be scanned and checked for normalization (i.e. corresponding interpretations by matching with normalization dictionary). In one embodiment, Normalization module 118C, may chose a number of word-senses within the normalization dictionary and present them to the user. In that embodiment, normalization module 118C may chose multiple word-senses which correspond to the information to be normalized and present them to the user.

In the present embodiment, normalization module 118C, uses dictionary 318 to normalize the information to be normalized (i.e. * and **) and replaces the lexical values with the word-senses of dictionary 318. Normalization module 118C also replaces the empty node with the newly normalized version in node 320.

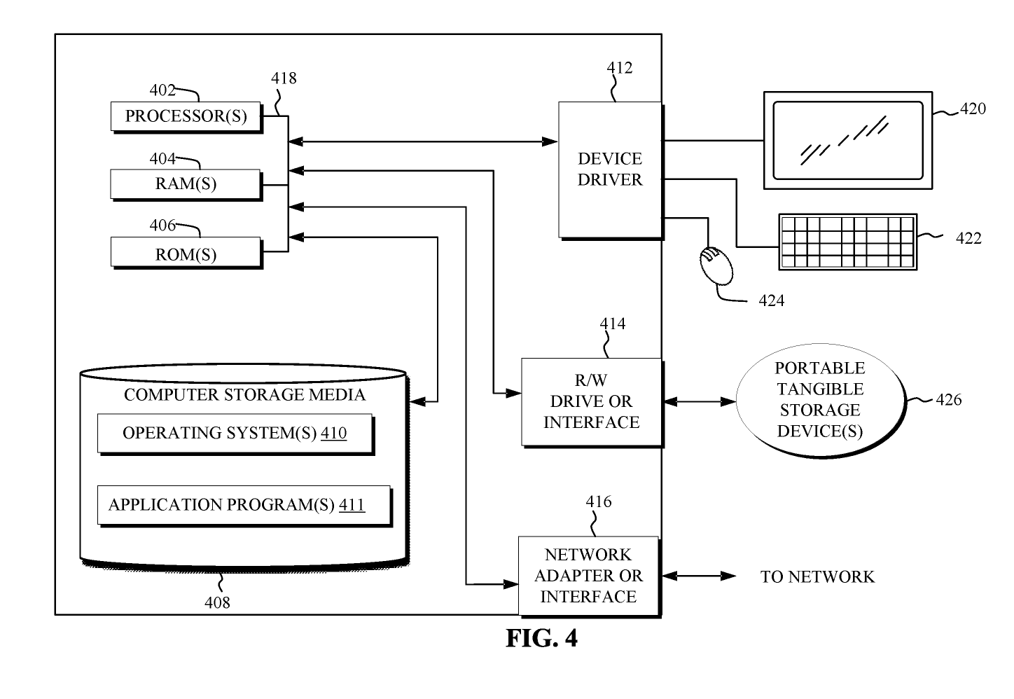

Referring now to FIG. 4 of components a computer system, for example server 112 and data source 120, of distributed data processing environment 100 of FIG. 1, in accordance with an embodiment of the present disclosure.

Server 112 may include one or more processors 402, one or more computer-readable RAMs 404, one or more computer-readable ROMs 406, one or more computer readable storage media 408, device drivers 412, read/write drive or interface 414, network adapter or interface 416, all interconnected over a communications fabric 418. Communications fabric 418 may be implemented with any architecture designed for passing data and/or control information between processors (such as microprocessors, communications and network processors, etc.), system memory, peripheral devices, and any other hardware components within a system.

One or more operating systems 410, and one or more application programs 411, are stored on one or more of the computer readable storage media 408 for execution by one or more of the processors 402 via one or more of the respective RAMs 404 (which typically include cache memory). In the illustrated embodiment, each of the computer readable storage media 408 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Server 112 and computer 102 may also include an R/W drive or interface 414 to read from and write to one or more portable computer readable storage media 426. Application programs 411 on server 112 and computer 102 may be stored on one or more of the portable computer readable storage media 426, read via the respective R/W drive or interface 414 and loaded into the respective computer readable storage media 408.

Server 112 may also include a network adapter or interface 416, such as a TCP/IP adapter card or wireless communication adapter (such as a 4G wireless communication adapter using OFDMA technology). Application programs 411 on server 112 and may be downloaded to the computing device from an external computer or external storage device via a network (for example, the Internet, a local area network or other wide area network or wireless network) and network adapter or interface 416. From the network adapter or interface 416, the programs may be loaded onto computer readable storage media 408. The network may comprise copper wires, optical fibers, wireless transmission, routers, firewalls, switches, gateway computers and/or edge servers.

Server 112 and computer 102 may also include a display screen 420, a keyboard or keypad 422, and a computer mouse or touchpad 424. Device drivers 412 interface to display screen 420 for imaging, to keyboard or keypad 422, to computer mouse or touchpad 424, and/or to display screen 420 for pressure sensing of alphanumeric character entry and user selections. The device drivers 412, R/W drive or interface 414 and network adapter or interface 416 may comprise hardware and software (stored on computer readable storage media 408 and/or ROM 406).

While the present invention is particularly shown and described with respect to preferred embodiments thereof, it will be understood by those skilled in the art that changes in forms and details may be made without departing from the spirit and scope of the present application. It is therefore intended that the present invention not be limited to the exact forms and details described and illustrated herein, but falls within the scope of the appended claims.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Based on the foregoing, a computer system, method, and computer program product have been disclosed. However, numerous modifications and substitutions can be made without deviating from the scope of the present disclosure. Therefore, the present disclosure has been disclosed by way of example and not limitation.

1. A computer-implemented method for normalizing data tables, comprising:
identifying and interpreting a plurality of lexical values within a data table;
identifying and interpreting a structure of the data table;
transforming the data table into a tree form, wherein the tree form simulates a hierarchical tree structure representing a relationship among the plurality of lexical values as a set of linked nodes;
identifying information to be normalized, wherein the information to be normalized is not defined within the data table;
generating a normalization dictionary comprising one or more arrays of aggregated statistical information of lexical values and corresponding word-senses; and
normalizing the information to be normalized using the normalization dictionary.

2. The method of claim 1, wherein the data table includes information presented in a structured or semi-structured way.

3. The method of claim 1, wherein the normalization dictionary is augmented by externally supplied dictionaries.

4. The method of claim 1, wherein the lexical values and corresponding word-senses of the normalization dictionary are generated based on corpus of the data table.

5. The method of claim 1, wherein the lexical values and corresponding word-senses of the normalization dictionary are generated based on corpus of any documents received in conjunction with the data table.

6. The method of claim 1, wherein the information to be normalized is missing data from the data table.

7. The method of claim 1, wherein the information to be normalized is not homogeneous with respect to other lexical values within the data table.
